(19) United States
(12) Patent Application Publication
(10) Pub. No.: US 2016/0127346 A1
(43) Pub. Date: May 5, 2016

(54) MULTI-FACTOR AUTHENTICATION

(71) Applicant: Verayo, Inc., San Jose, CA (US)

(72) Inventors: William Henry BARES, San Jose, CA (US); David M'RAIHI, San Carlos, CA (US); Eric DUPRAT, Los Altos, CA (US)

(73) Assignee: Verayo, Inc., San Jose, CA (US)

(21) Appl. No.: 14/294,142

(22) Filed: Jun. 2, 2014

Related U.S. Application Data
(60) Provisional application No. 61/830,628, filed on Jun. 3, 2013.

(51) Int. Cl. H04L 29/06

(52) U.S. Cl. CPC H04L 63/083; H04L 63/0807; H04L 63/0861

(57) ABSTRACT

The disclosed invention is a system and method that allows for authentication of a user to a network using a token. The user can use movements or gesture that are recorded by an accelerometer and the token interacts with a device and authenticates the user to the system. The token may be part of the device or stand alone. The various aspects of the present invention capture a novel design for an authentication token that authenticated the token and the user of the token.

### CROSS REFERENCE

Pursuant to 35 U.S.C. §119(e), this application claims priority to the filing date of U.S. Provisional Patent Application Ser. No. 61/830,628 filed on Jun. 3, 2013 (Titled MULTI-FACTOR AUTHENTICATION), the entire disclosures of which application is incorporated herein by reference.

### FIELD OF THE INVENTION

The present invention is related to systems for security and, more specifically, to multifactor authentication (MFA) access to a secure network.

### BACKGROUND

Most authentication tokens require user interface or user interaction. Existing authentication tokens require some user intervention, either to plug-in the token to a device or simply to generate the authentication value (by pressing a button, launching an application, etc.) and subsequently entering/reading this value for granting access to an application, resource or service. Also, once authenticated, a secure connection is created without continued monitoring.

Thus, if the user walks away from the terminal or the computer, and does not close out the secure session, then others can access the system through the secure session. This is a common problem because the user does not want the hassle of having to re-authenticate every time the user has to leave the terminal and return later, especially if it is for a short period of time. Hence, the user will not shut down or terminate the session before walking away from the terminal. Additionally, there are instances wherein the system needs to confirm that the user of the token is actually authorized to use the token. Therefore, what is needed is a system and method for authentication of a user with limited user interaction when the user is ready and proximate to the terminal.

### SUMMARY

The disclosed invention is a system and method that allows for authentication of a user to a network using a token with limited or minimal user interaction and when the user is proximate to a device or terminal. The token interacts with the device and authenticates the user as the user provides a gesture or movement that can act as a password because it is uniquely known by the user. The various aspects of the present invention capture a novel design for an authentication token that includes the following new set of properties that includes any one of the following: Wireless communication; Authentication Credential Generation Token; and Limited or no human/user interaction.

A token is also referred to as Authentication Token Without Human Intervention (ATWHI) herein in accordance with various aspects of the present invention.

### DESCRIPTION OF DRAWINGS

Drawings are intended to be illustrative, to those of skill in the art, of particular aspects of the invention and are not necessarily to scale, and each is not necessarily inclusive of all aspects.

FIG. 1 shows the display of a device used in accordance with the teachings of the present invention.

FIG. 2 shows a block diagram of a token used in a system in accordance with the teachings of the present invention.

FIG. 3 shows verification of a user using a system in accordance with one aspect of the present invention.

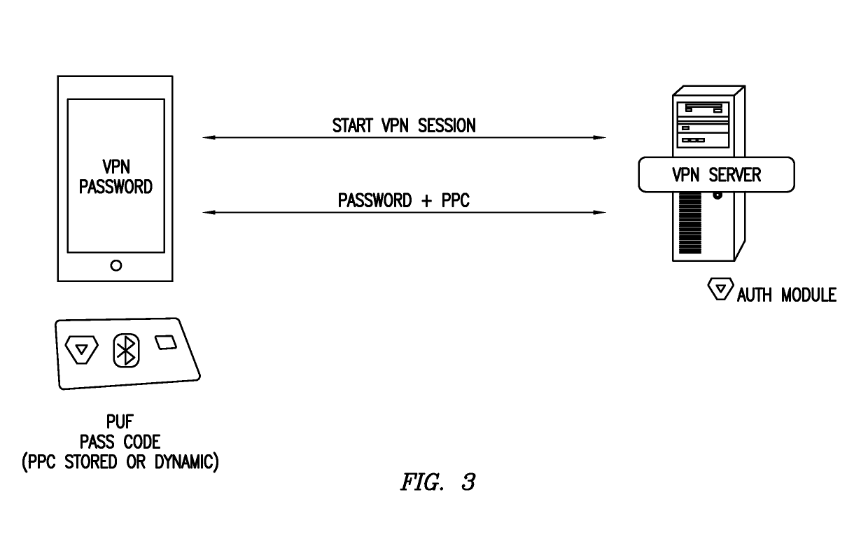

FIG. 4 shows verification of a user based on proof of presences in accordance with the teachings of the present invention.

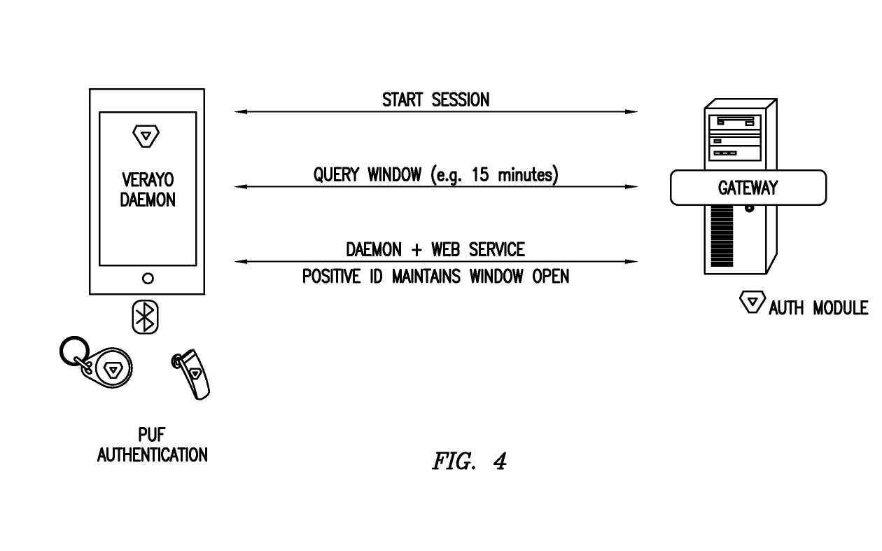

FIG. 5 shows verification of a user using a token and a device in accordance with the teachings of the present invention.

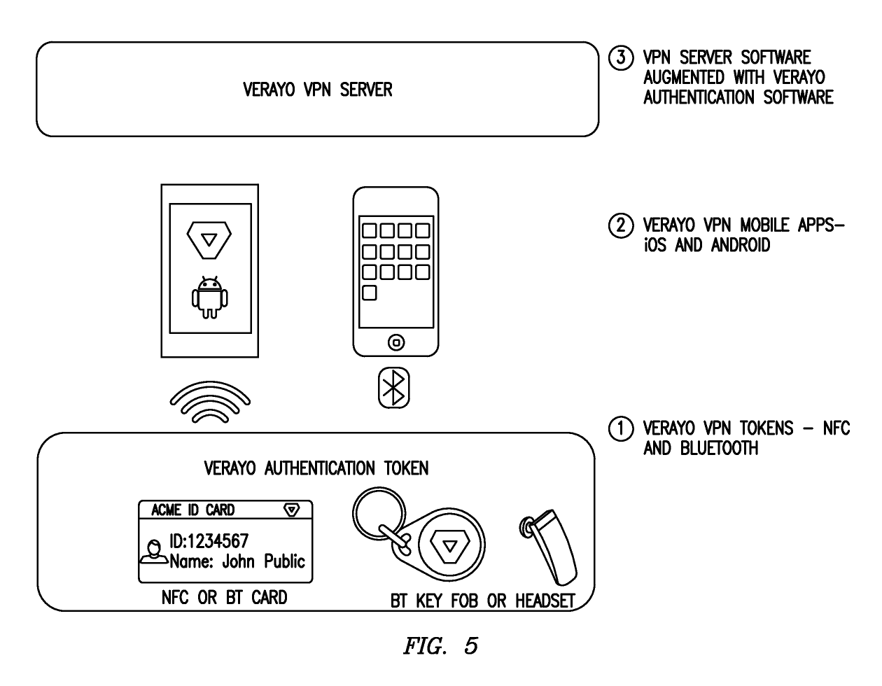

FIG. 6 shows verification using a Physically Unclonable Function (PUF) based credentials and hardware security object in accordance with the teachings of the present invention.

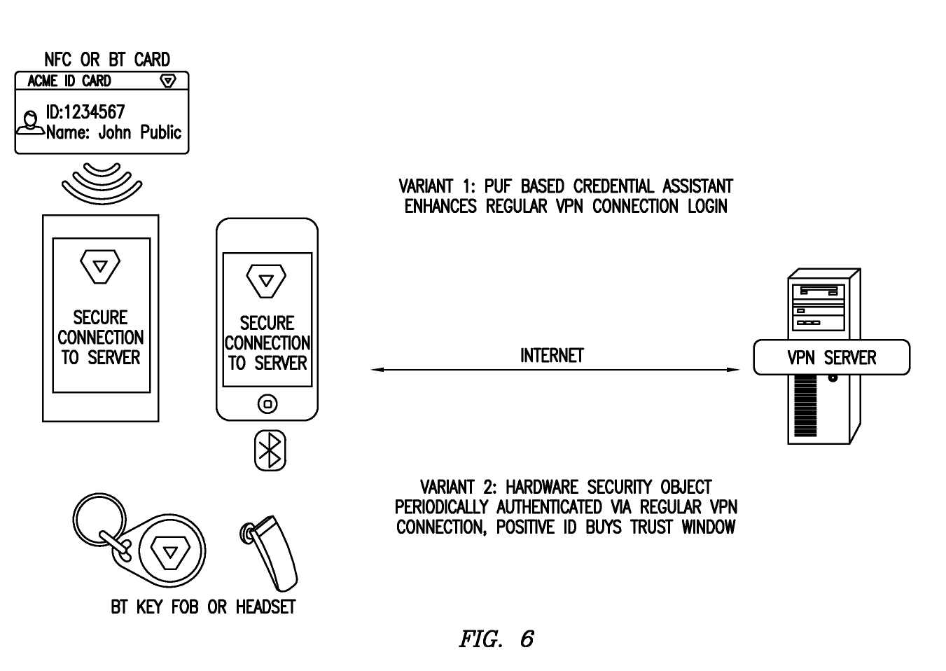

FIG. 7 shows the topology of a system in accordance with the teachings of the present invention.

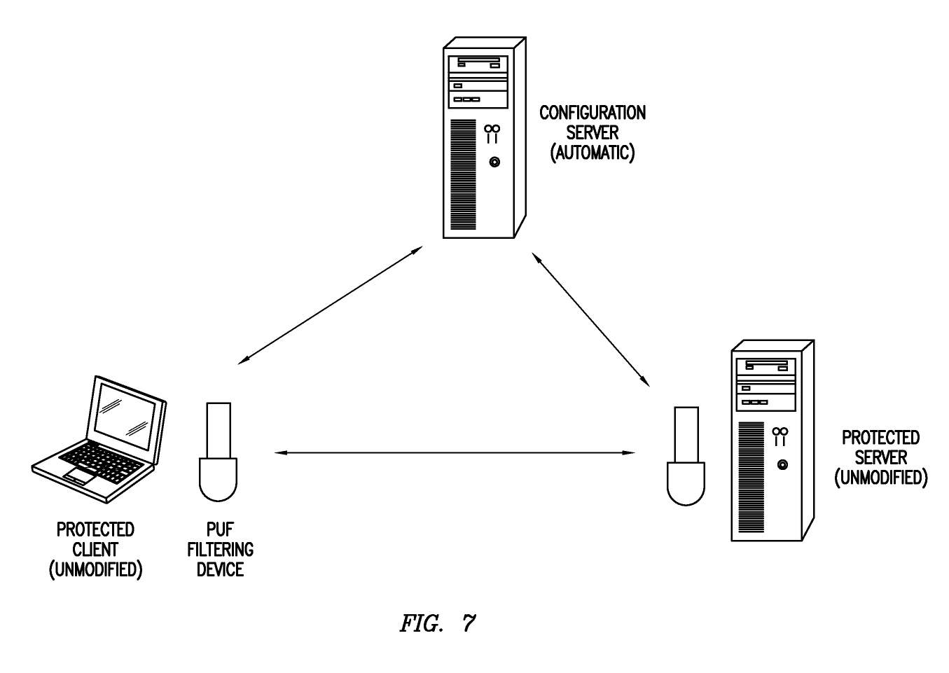

FIG. 8 shows a block diagram for an authentication approach using an authentication algorithm with secure memory and optional key management layer in accordance with the teachings of the present invention.

FIG. 9 shows a block diagram of a chip with various modules and functions in accordance with the teachings of the present invention.

FIG. 10 shows a system for location verification of a user in accordance with the teachings of the present invention.

FIG. 11 shows a system using Software as a Service (SaaS) with an IDentity Provider being the gateway and using a token for added security in accordance with the teachings of the present invention.

### DETAILED DESCRIPTION

In accordance with the various aspects and teachings of the present invention, authentication is based on a hardware token including wireless (BT LE is the method of choice but NFC, WiFi direct, Plain vanilla Bluetooth, other wireless protocols are valid options) communication capability and enough logic to compute and communicate, through at least the wireless connection, an authentication credential or token that can be further consume by an application running on a device supporting wireless communication, and an application layer to take advantage of the computed authentication value.

Direct Integration on Mobile Devices

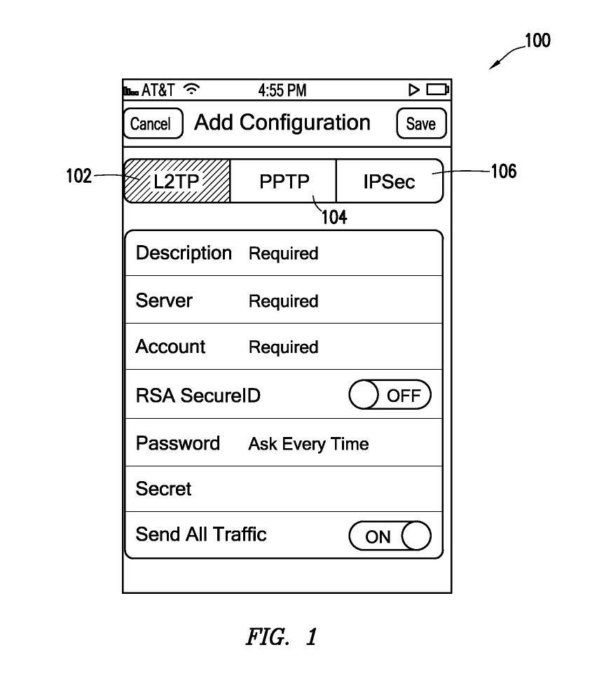

Referring now to FIG. 1, a screen shot 100 of a device is shown with L2TP 102, PPTP 104, IPSec 106 options. A VPN solution is integrated on the device. For instance, iOS devices support, by default, the following VPN configurations: L2TP, PPTP and IPSec. These configurations support authentication tokens (such as RSA SecurID) or certificates as part of the VPN authentication mechanism. In accordance with one aspect of the present invention, a token solution would be to integrate the Authentication Token Without Human Intervention (ATWHI) as a possible choice for a token, within the supported configurations. Namely, ATWHI will appear as a possible choice for all VPN configurations.

In case the ATWHI option is selected, the field for entering the Secret will not be needed anymore. Upon VPN request or interrogation, the token will communicate automatically the authentication code or certificate that will replace the former supported token expected secret value—the value that user was entering manually after operating his token. In the case of the certificate, the VPN configuration will use ATWHI computed value as an authenticator rather than relying on the user certificate to compute a cryptogram.

Integration at the Application Level

In accordance with one aspect of the present invention, the integration is at the client software level:

Intercepts (VPN) Password Entry

Accepts Human Password/PIN

Communicates with ATWHI

Adds Machine Pass value from ATWHI

All other operations use regular (VPN) gateway

In accordance with the present invention there is a combination of credentials from the user and the token and there is no human interaction required to operate the token (be it reading a value, entering a value, etc.) since the token will automatically communicate the computed value or the authentication certificate upon request from the application. In accordance with another aspect of the present invention, a setting can be defined where simply the authentication value computed by the token is required to grant access to a specific resource (say, storage) or application, service.

In accordance with another aspect of the present invention, the caching of password is protected by adding the ATWHI and potentially performs a local verification before unlocking the password. This requires verification on the device versus or in addition to verification on the server or authentication authority. In accordance with the present invention both implementations encompassing the two layers of security:
local verification that unlocks the cached password;
server verification of a second authentication code, plus the password.

In accordance with the teachings of the present invention as in the foregoing example, the ATWHI would generate 2 authentication codes. Thus, there is a local verification as well as a remote verification.

In accordance with another aspect of the present invention, a daemon application can be included that is constantly running on the device. The device will ping automatically within a certain time window the ATWHI to confirm the presence (notion of proof of presence) or proximity of the token. This aspect of the present invention would use the VPN as a use case:

Client Software—Network Daemon
Always running (suspended waiting for server)
Expects regular VPN tunnel to Server
On demand connects with PUF hardware (fob)
Facilitates authentication of PUF (signing protocol)
Establishment of Positive ID opens a trust window

Server Software—started on VPN connect
Gates VPN connection forward to Intranet
Guards window by keeping positive ID on Client

Another aspect of the present invention is that the daemon running on the device could serve different applications. For example various authentication codes could be computed and communicated on a need-to-know basis. The daemon becomes the center of authentication for the device, interrogating the ATWHI and injecting the authentication codes when needed.

ATWHI Block Diagram

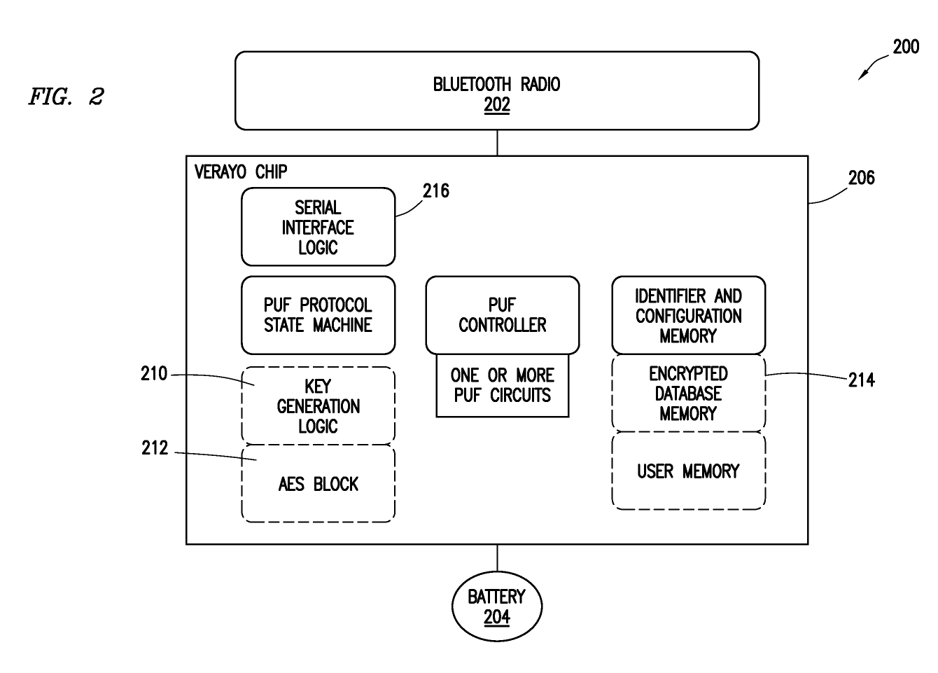

Referring now to FIG. 2, a block diagram is shown that describes the main components of a token 200 for generating codes, keys, or authentication credentials in accordance with one aspect of the present invention. The token 200 includes a battery 204 coupled to a chip 206, which is referred to as a Verayo Chip for simplicity and clarity. The chip 206 is coupled to a Bluetooth (BT) radio or chip/component/module 202 for communication.

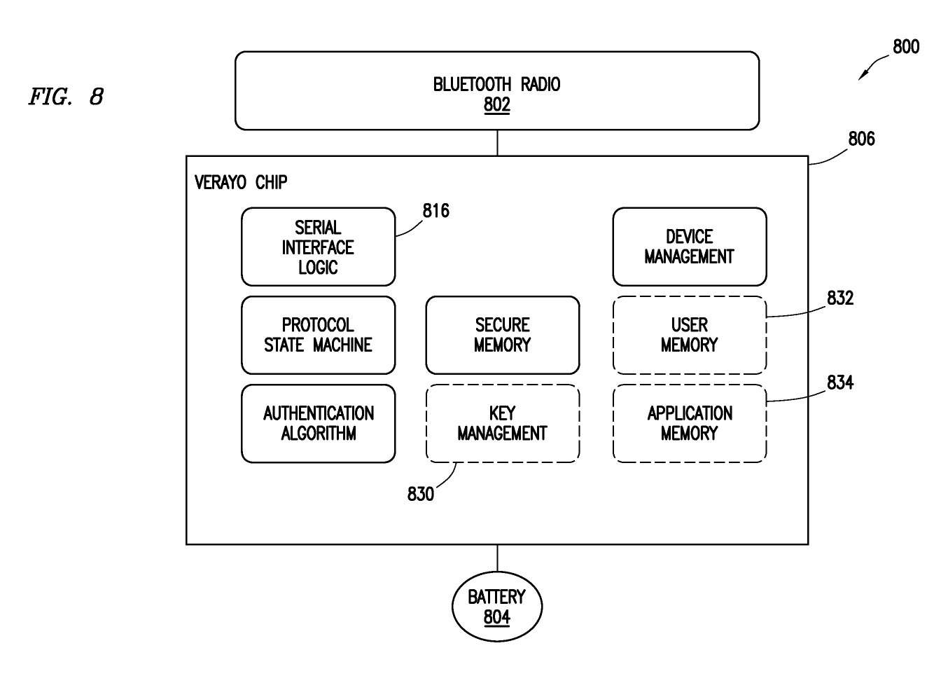

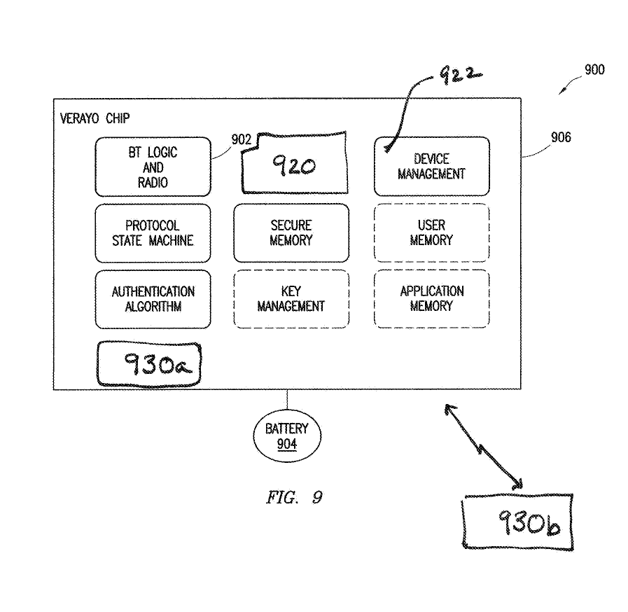

In accordance with another aspect of the present invention and referring now to FIG. 8 and FIG. 9, a token or device is shown with various implementations according to the various aspects of the present invention. Several components are optional, depending on the set of features and/or technology options.

In accordance with one aspect of the present invention, if there is reliance upon the PUFs technology to generate an authentication credential, then FIG. 8 shows a token 800 that includes an battery 804 coupled to a chip 806, which includes a serial interface 816 with optional components including a key management module and memory portions 832 and 834.

Referring again to FIG. 2 and in accordance with another aspect of the present invention, a key is generated that is derived from PUF material, then the token 200 includes a Key Generation block or component/module 210 as well as an encryption (AES) function block or component/module 212 to take advantage of the generated key.

In accordance with another aspect of the present invention, the system includes protected (encrypted) memory 214 on the token 200. The token 200 includes a communication (serial) interface 216 to the BT module 202 (or other wireless protocols), enough logic to interact with the PUF and manage the computation of authentication codes (and possibly key generation and further usage of the key material by the AES/encryption block) and their communication to the outside world through the Verayo Chip interface and the BT module 202 for wireless communication.

Referring now to FIG. 9 and in accordance with another aspect of the present invention, a token 900 is shown with a batter 904 coupled to power a chip 906. The chip 906 includes a BT module 902 that is similar to the chip 202 of FIG. 2 or the chip 802 of FIG. 8. Thus, it will be apparent that the location of the BT module does not impact the scope of the present invention. Furthermore, it will be apparent that any wired or wireless protocol may be deployed in place of the BT module.

In accordance with the various aspects of the present invention, an accelerometer 920 is shown. Upon set-up of the token, the user can create a gesture or movement based password or recognition gesture. This movement or gesture is recorded by the accelerometer 920. The accelerometer 920 provides the information/data associated with the gesture to a processor. In accordance with one aspect of the present invention the processor is part of the BT module 902. In accordance with another aspect of the present invention, the processor can be stand-alone or part of a different module of the token 900.

The processor or memory associated therewith, in accordance with the various aspects of the present invention, can then store the gesture or movement. In accordance with another aspect of the present invention, the processor can forward the recorded gesture or movement to an authenticating authority (not shown). The authenticating authority verifies the gesture or movement password to confirm that the user is an authorized user. Since the authenticating authority authorizes and enables access to the protected resource, it would want to store the gesture for future recognition. Thus, the accelerometer 920 provides a second form of authentication. The accelerometer 920 is in communication with the device management module 922.

Once the user needs access and in accordance with an aspect of the present invention, the user would move the token 900 through the series of gestures or movements that were performed as part of the set up process. The specific pattern of movement or gesture would be recognized by the accelerometer 920 as the password. This would verify the presence of the token 900 as well as the user. In accordance with the various aspects of the present invention, other bio or physical parameters can be used to authenticate a user, such as walking speed or walking patterns that can be recorded or detected by the accelerometer. Thus, dual factor authentication.

Furthermore, in accordance with other aspects of the present invention, multiple users can use the same token 900. At the time setup, the second user would provide a unique gesture or movement of the token 900. Again, the accelerometer 920 would record the gestures and movements as being unique to the second user. Thus, each user has a unique gesture or movement that is recognized by the accelerometer 920.

In general, the accelerometer 920 can ensure that somebody is really present, with the token. Thus, access is limited to a user being present and knowing that specific movement/gesture. Thus, simply having the token will not be sufficient to authenticate the user and allow access.

In accordance with another aspect of the present invention, the accelerometer 920 can measure the distance or height of the token, as well as the speed of the movement to generate a password based gesture that incorporated the unique gesture with the speed of movement through the gesture. The gesture password be harder to duplicate because now the gesture/movement as well as the speed of movement must be replicated.

Referring again to FIG. 9, in accordance with another aspect of the present invention, the token 900 includes a sensor 930a. The sensor 930a is part of the token 900. In order to ensure limited demands on the user for authentication, the sensor 930a can be used. In accordance with one aspect of the present invention, the sensor 930a would include a display (not shown). In accordance with another aspect of the present invention, the sensor 930a would be in communication with a display that is part of the token 900. The user would place his or her hand on the display. The sensor 930a would record the distance between the fingers of the user, the size of the fingers, or any other biometric parameter that is unique or specific to the user. For example, if the token 900 was an touch tablet or included as part of the touch tablet, then a measure of the distance between fingers upon set up, would be used to authenticate a user.

In accordance with the present invention, the sensor 930b is located outside the token 900 and in communication with the token 900. As outline with respect to the sensor 930a, all functions are similar between the sensor 930b and the sensor 930a.

ATWHI and HID (or Similar) Combo Token

Another aspect of the present invention is a combination of the ATWHI functionality and an access card, such as a HID access card, within the same token. The resulting token will enable a user to:
access controlled/restricted applications, resources and services by using the ATWHI part of the token and the wireless (BT, NFC, etc.) interface; and
open an office door with the same token, using the access card part of the token through the RFID interface.

The two parts will be independent and use different method of communications. The novelty lies in the combination of the Authentication Token without Human Intervention (ATWHI) and the Access Card into a single token that can be seen as a universal enterprise token to enable IT to manage all access to logical (applications, services, storage, etc.) and physical (doors, locks, etc.) resources.

PUF is an acronym for Physical(ly) Unclonable Function. The first word, physical, implies that a PUF is something tangible, as opposed to, say, a mathematical formula or computer algorithm. It is therefore a physical object, a machine, an instance of usually complex elements.

The second word is unclonable. To be truly unclonable, this PUF object/machine must be impossible for people (and their machines, such as computers) to duplicate (copy, clone, repeat). This also means that every PUF is unique—there is exactly up to one instance of each PUF in the whole universe. The function part of the name annotates a PUF property to transform an input variable (or a collection of such variables), into an output variable (or a collection thereof), similar to a conventional mathematical function:

R=PUF(C)

Unlike a mathematical function, the Physical Unclonable Function is by definition not possible to replace, decompose, express or define by deterministic, mathematical symbols. There is a particular reason the variables in the above formula are labeled R and C.

The input one is called Challenge while the output of the PUF is called Response. In accordance with the various aspects of the present invention, the Response is also used to derive, or form in part or whole, authentication credentials. The PUF functionality is limited to its uniqueness, otherwise, the values of R and C can be just about anything that lay within operational range of each particular implementation of a PUF. But since every PUF is different and unpredictable, so are its responses. Still, while random across a population of PUFs, each instance of a PUF is consistent with itself, i.e. it produces the same (or, to be precise, nearly same) response every time a particular challenge is given. On the other hand, each PUF produces a different (or, to be precise, quite likely different) response for a particular challenge. Thus, the most important PUF property is that, for every otherwise identically created PUF instance, each gives a different/unique Challenge/Response Pair (CRP). The CRPs of a well-designed PUF satisfy these criteria:
Random: every CRP is unpredictable until actually produced by the PUF.
Unique: every CRP is unique among all other CRPs, with every single PUF and among any number of PUFs.
PUF1(C1)≠PUF2(C2) for C1≠C2 and PUF1=PUF2, and PUF1(C1)≠PUF2(C2) for C1=C2 and PUF1≠PUF2.
Reliable: Every Response to each particular Challenge to the same PUF remains consistent across time and a practical range of operational conditions (e.g. temperature).
Complex: CRPs must be large (bit-wise) so that it is impractical to collect their exhaustive library.
Hard: PUF functionality must be very difficult (and ultimately impractical) to model (e.g. by machine learning) from knowing even a large number of CRPs.

It is to be understood that this invention is not limited to particular embodiments or aspects described, as such may vary. It is also to be understood that the terminology used herein is for the purpose of describing particular embodiments only, and is not intended to be limiting, since the scope of the present invention will be limited only by the appended claims.

Lock/Unlock

In accordance with another aspect of the present invention, the ATWHI could be used to lock/unlock a terminal or access device. For example, the ATWHI is in the user's pocket and a smart communication device or personal communication device can be used (e.g. smart phone or tablet) to access the ATWHI and unlock the access device to allow access to the system. If the smart communication device is not present, then the terminal or access device remains locked.

In accordance with another aspect of the present invention, a Personal Identification Number (PIN_can be combined with having the ATWHI in your pocket or near/at the user's desk and proximate enough so that the terminal or access device can get an authentication code from the token, either directly or through the smart communication device. If the system requires continued authentication or verification, then the user would not need to enter a PIN every time. Having the ATWHI nearby allows for the authentication authority to request a response by sending a challenge. The token or ATWHI would send the response as the authenticating credential.

In accordance with another aspect of the present invention, the access terminal or access device's screen saver can be locked and unlocked. The screen saver would be unlocked if the ATWHI is nearby. Accordingly, the user would not need to enter a password every time the screen saver needs to be unlocked.

In accordance with another aspect of the present invention, the user would need to enter a password or a PIN in addition to having the ATWHI or token nearby/present. In accordance with another aspect of the present invention, the system can allow the user to unlock the screen saver with either an ATWHI being nearby or entering a password or PIN.

Local Verification

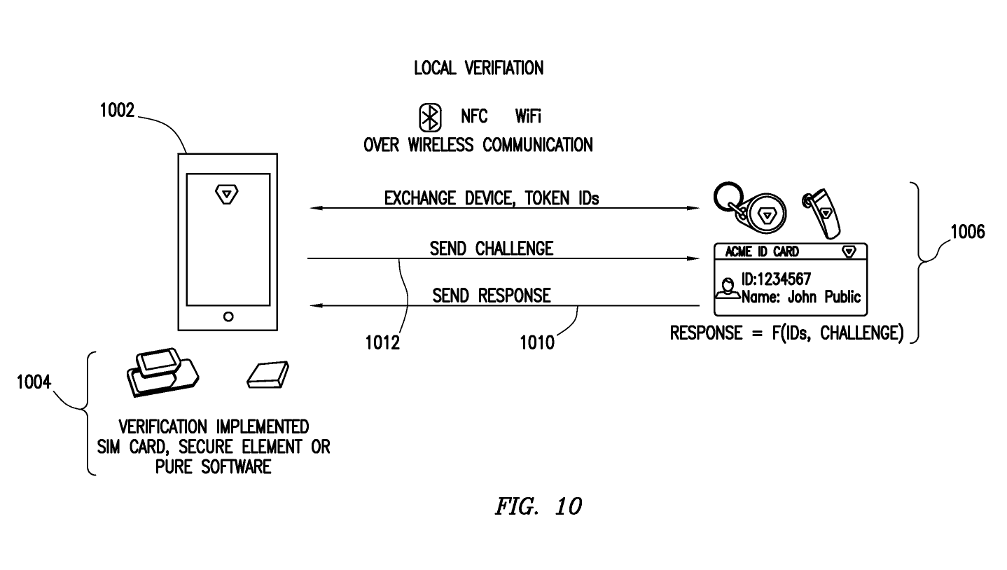

Referring now to FIG. 10, local verification is implemented on a device 1002, such as a smart device, smart phone, tablet, personal computer (including a laptop or desktop). In accordance with the present invention, the verification information can reside inside a tamper resistant component 1004, such as a Secure Element (SE) or a SIM card. A local response to a specific challenge 1012 is recomputed in the component 1004 and compared to a response 1010 computed by a token 1006. The verification can be implemented directly in software, if possible including some protections such as obfuscation, data encryption, etc. to prevent hacking the verification process easily.

Similarly and in accordance with another aspect of the present invention, the local response to the specific challenge 1012 is recomputed by a software verification module and compared to the response 1010 computed and sent by the token 1006. In both cases, if there is a match, the token 1006 is authenticated and the device 1002 can grant access, unlock, etc. depending on the application and use case.

As shown in FIG. 10, the response is computed as: Response=F (Challenge, IDs) that is, the Response is a function of the random challenge, sent by the device, and the different Identifiers used in the protocol. The IDs can be used directly in the computation. For example, if F is the HMAC function with a key (K), the Response will be computed as a function of the K, Challenge and IDs.

In accordance with the teachings of the present invention, F can be the following:
a MAC (Message Authentication Code) function such as HMAC or an AES-based MAC;
an encryption function, for instance AES or RSA;
a PUF-based authentication function;
any custom authentication process based on a combination of the previous functions; or
derived from these functions, such as the OATH algorithms (HOTP, TOTP, OCRA, etc.) for instance.

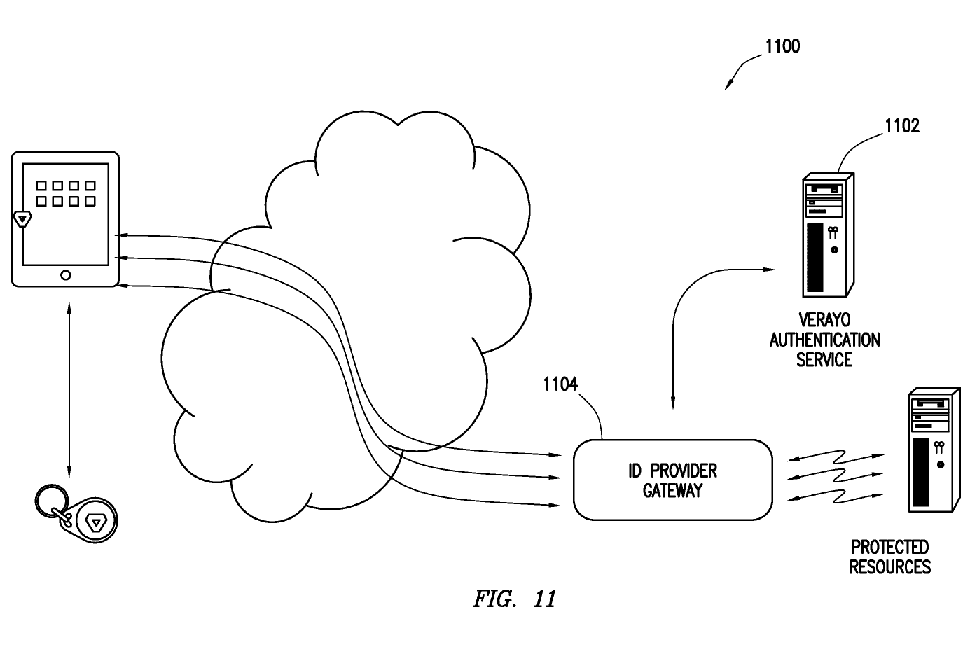

Referring now to FIG. 11, a system 1100 is shown in accordance with the various aspects of the present invention. The system 1100 includes an Authentication Service 1102 that can be a standalone box/server/service located outside or it can also be in the same premises as the ID provider gateway 1104.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof.

Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

In accordance with the teaching of the present invention and certain embodiments, a computer device is an article of manufacture. Examples of an article of manufacture include: an electronic component residing on a mother board, a server, a mainframe computer, a mobile telephone, a multimedia-enabled smartphone, a tablet computer, a personal digital assistant, a personal computer, a laptop, a set-top box, an MP3 player, an email enabled device, a web enabled device, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

The article of manufacture (e.g., computing device) includes a non-transitory computer readable medium having a series of instructions, such as computer readable program steps encoded therein. In certain embodiments, the non-transitory computer readable medium includes one or more data repositories.

In certain embodiments and in accordance with any aspect of the present invention, computer readable program code is encoded in a non-transitory computer readable medium of the computing device. The processor, in turn, executes the computer readable program code to create or amend an existing computer-aided design using a tool. In other embodiments, the creation or amendment of the computer-aided design is implemented as a web-based software application in which portions of the data related to the computer-aided design or the tool or the computer readable program code are received or transmitted to a computing device of a host.

A controller is meant to represent a control element for the invention, which manages local processes within the battery and communicates these or the results of these to an external control system. The controller can be implemented in a variety of ways:
with one or more distinct microprocessors, volatile and/or non-volatile memory and peripherals or peripheral controllers;
with an integrated microcontroller, which has a processor, local volatile and non-volatile memory, peripherals and input/output pins;
discrete logic which implements a fixed version of the control system;
programmable logic which implements a version of the control system which can be reprogrammed either through a local or remote interface. Such logic could implement either a control system either in logic or via a set of commands executed by a soft-processor.

In certain embodiments based on the various aspects of the present invention, reference is made to communication between two electronic components. In certain embodiments, the communication fabric contains either or both wired or wireless connections for the transmission of signals including electrical connections, magnetic connections, or a combination thereof.

In certain embodiments, the system includes a hardware-based module (e.g., a digital signal processor (DSP), a field programmable gate array (FPGA)) and/or a software-based module (e.g., a module of computer code, a set of processor-readable instructions that are executed at a processor). In some embodiments, one or more of the functions associated with the system 100 is performed, for example, by different modules and/or combined into one or more modules locally executable on one or more computing devices.

Accordingly, the preceding merely illustrates the various aspects and principles of the present invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A system for authentication comprising:
a token for providing a secure identification code, the token including an accelerometer module that records a gesture password created by a user; and
a device that includes an authentication authority, the device establishes a communication link with the token to exchange device identification data with the token,
once the device identification data is exchanged with the token, the device interrogates the token for the code and the gesture password and the token provides the code and the user provides the gesture password to the accelerometer module such that the authentication authority locally authenticates the token and the user to allow access to the device.

2. The system of claim 1, wherein the device is a mobile phone.

3. The system of claim 1, wherein the device is a computer.

4. The system of claim 1, wherein the gesture password is stored in the device.

5. The system of claim 1, wherein the gesture is stored in the token.

6. The system of claim 1, wherein the token records a second gesture password for a second user to allow the second user to use the token to access the device.

7. A system for authentication comprising:
a token for providing a secure identification code, the token including a sensing device, that can digitize user interaction; and
a device in communication with an authentication authority, the device establishes a communication link to the token to exchange device identification data with the token,
wherein, once the device identification data is exchanged with the token, the device interrogates the token for the code and the digitize user interaction and the token provides the code and the digitize user interaction as a password using the sensing device, such that the authentication authority authenticates the token based on the secure identification code and the user based on the password to allow access to at least one of the device and another secure resource.

8. The system of claim 7, wherein the sensing device is an accelerometer.

9. The system of claim 7, wherein the sensing device measures distance between fingers and the password is user's movement of fingers on the device.

10. The system of claim 7, wherein the device is a mobile phone.

11. The system of claim 7, wherein the password is a gesture password and stored in the device.

12. The system of claim 11, wherein the gesture password is stored in the token.

13. The system of claim 7, wherein the token records a digitized user interaction that is used to generated a second gesture password for a second user to allow the second user to use the token to access the device.

14. A method for authentication, the method comprising the steps of:
establishing a first communication link between a token and a device;
exchanging the device identification data with the token;
interrogating the token for a secure identification code and a password;
establishing a second communication link between the device and an authentication authority to provide the code and the password to the authentication authority; and
authenticating, using the authentication authority, the token and a user to allow access to at least one of: the device and other secure resource.

15. The method of claim 14, wherein the step of interrogating includes the token providing the code.

16. The method of claim 14, wherein the step of interrogating includes the user providing a gesture that is captured by the token through a sensing module of the token and digitized using the sensing module to become the password.
